(19) United States
(12) Patent Application Publication
(10) Pub. No.: US 2004/0129395 A1
(43) Pub. Date: Jul. 8, 2004

(54) Strengthened tissue paper products comprising low levels of xylan

(75) Inventors: Frank Rehders, Munden (DE); Jeffrey Glen Sheehan, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/676,397

(22) Filed: Oct. 1, 2003

Related U.S. Application Data
(60) Provisional application No. 60/415,051, filed on Oct. 1, 2002.

(51) Int. Cl. B31F 1/12; D21H 17/24; D21H 27/30

(52) U.S. Cl. 162/111; 162/175; 162/123

(57) ABSTRACT

Disclosed is a tissue paper product comprising one or more plies of a tissue paper; wherein at least one of the plies comprises cellulose and from about 0.005% to about 0.14% by weight based on the weight of cellulose of xylan. Also disclosed is a process for making tissue paper products comprising these ultra low level of xylan.

### CROSS REFERENCE TO RELATED APPLICATIONS

This application claims the benefit of U.S. Provisional Application No. 60/415,051, filed Oct. 1, 2002.

### TECHNICAL FIELD

This invention relates, in general, to tissue paper products which are strengthened by extremely low levels of xylan and the processes for making such papers.

### BACKGROUND OF THE INVENTION

The use of hemicellose compounds is well known in the paper making industry. The effect of xylan, isolated from corn cobs, on the properties, in terms of paper making technology, of laboratory test sheets of printing paper and wrapping paper was examined in the past. See Publication in the Czech magazine “papir a celuloza”, 41, (7-9) 1986, pages V23 to V30, of Anna Naterova et al., “Einsatz von Xylan bei der Papierherstellung”. During the manufacture of wrapping paper with the content of 50% of short fiber material the flexural strength is quoted to increase by 172% after the addition of 2% xylan. The same addition of xylan improved the IGT linking strength of a printing paper and prevented the two-sided effect.

Commonly assigned U.S. Pat. No. 5,810,972 issued to Reinheimer et al. on Sep. 22, 1998 discloses processes for making tissue papers comprising hemicelluloses by adding the hemicellulose to the wet cellulose pulp used to make the paper either before depositing the pulp on a forming wire, or after depositing the pulp on the wire but before the pulp is drained. U.S. Pat. No. 5,810,972 specifically discloses the use of from 0.15% to 1.5% of xylan based on the weight of the cellulose to strengthen the tissue paper without compromising softness.

Surprisingly, it has been found that levels much lower than previously taught provides increased paper strength and not decreased strength due to the lower levels as would be expected. Such improved products, compositions, and processes are provided by the present invention as is shown in the following disclosure.

### SUMMARY OF THE INVENTION

The present invention relates to a tissue paper product comprising one or more plies of a tissue paper; wherein at least one of the plies comprises cellulose and from about 0.005% to about 0.14% by weight based on the weight of cellulose of xylan.

### DETAILED DESCRIPTION OF THE INVENTION

The present invention provides a strengthened tissue paper which comprises one or more plies, where at least one of the plies comprises a xylan hemicellulose at surprisingly low levels. The resulting tissue paper has improved strength without significant loss in softness.

All documents cited are, in relevant part, incorporated herein by reference; the citation of any document is not to be construed as an admission that it is prior art with respect to the present invention.

All percentages, ratios and proportions herein are by weight, unless otherwise specified.

Tissue Paper

The present invention is applicable to tissue paper in general, including but not limited to: conventionally felt-pressed tissue paper; pattern densified tissue paper; and high-bulk, uncompacted tissue paper. The tissue paper may be of a homogenous or multilayered construction; and tissue paper products made therefrom may be of a single-ply or multi-ply construction. The tissue paper preferably has a basis weight of between about 10 g/m² and about 80 g/m², and density of about 0.60 g/cc or less. Preferably, the basis weight will be below about 35 g/m² or less; and the density will be about 0.30 g/cc or less. Most preferably, the density will be between about 0.04 g/cc and about 0.20 g/cc.

Conventionally pressed tissue paper and methods for making such paper are known in the art. See commonly assigned U.S. patent application Ser. No. 09/997,950 filed Nov. 30, 2001. One preferred tissue paper is pattern densified tissue paper which is characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Preferred processes for making pattern densified tissue webs are disclosed in U.S. Pat. No. 3,301,746, issued to Sanford and Sisson on Jan. 31, 1967, U.S. Pat. No. 3,974,025, issued to Ayers on Aug. 10, 1976, U.S. Pat. No. 4,191,609, issued to on Mar. 4, 1980, and U.S. Pat. No. 4,637,859, issued to on Jan. 20, 1987; U.S. Pat. No. 3,301,746, issued to Sanford and Sisson on Jan. 31, 1967, U.S. Pat. No. 3,821,068, issued to Salvucci, Jr. et al. on May 21, 1974, U.S. Pat. No. 3,974,025, issued to Ayers on Aug. 10, 1976, U.S. Pat. No. 3,573,164, issued to Friedberg, et al. on Mar. 30, 1971, U.S. Pat. No. 3,473,576, issued to Amneus on Oct. 21, 1969, U.S. Pat. No. 4,239,065, issued to Trokhan on Dec. 16, 1980, and U.S. Pat. No. 4,528,239, issued to Trokhan on Jul. 9, 1985.

Uncompacted, non pattern-densified tissue paper structures are also contemplated within the scope of the present invention and are described in U.S. Pat. No. 3,812,000 issued to Joseph L. Salvucci, Jr. and Peter N. Yiannos on May 21, 1974, and U.S. Pat. No. 4,208,459, issued to Henry E. Becker, Albert L. McConnell, and Richard Schutte on Jun. 17, 1980.

The tissue papers of the present invention may be dried to any moisture level know in the industry for making such papers. These levels typically result in reel moisture levels of from about 1% to about 8%. Similarly, the tissue papers of the present invention may be creped as is known in the industry. When creped, the % crepe can range from about 3% to about 22%.

The xylan of the present invention can also be applied to uncreped tissue paper. Uncreped tissue paper, a term as used herein, refers to tissue paper which is non-compressively dried, most preferably by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, Wendt, et. al. in European Patent Application 0 677 612A2, published Oct. 18, 1995; Hyland, et. al. in European Patent Application 0 617 164 A1, published Sep. 28, 1994; and Farrington, et. al. in U.S. Pat. No. 5,656,132 published Aug. 12, 1997.

Furnish

The papermaking fibers utilized for the present invention will normally include cellulose fibers derived from wood pulp. Other cellulosic fibrous pulp fibers, such as cotton linters, bagasse, etc., can be utilized and are intended to be within the scope of this invention. Synthetic fibers, such as rayon, polyethylene and polypropylene fibers, may also be utilized in combination with natural cellulosic fibers. One exemplary polyethylene fiber which may be utilized is Pulpex®, available from Hercules, Inc. (Wilmington, Del.).

Applicable wood pulps include chemical pulps, such as sulfite and sulfate pulps, as well as mechanical pulps including, for example, groundwood, thermomechanical pulp and chemically modified thermomechanical pulp. Chemical pulps, however, are preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. Also applicable to the present invention are fibers derived from recycled paper, which may contain any or all of the above categories as well as other non-fibrous materials such as fillers and adhesives used to facilitate the original papermaking.

Hemicellulose Xylan

Hemicellulose containing additives can be added during the manufacture of the pulp in the pulper—i.e. for instance in the machine vat—which goes along with an especially good mixing of the additives and the pulp. By alternative, if the additives are added during the supply of the pulp to the wire, they can virtually be added in-situ prior to the material accumulation on the wire. Further, it is possible to add the additives to the refining pulper directly after the refining treatment of the cellulose raw material.

Fundamentally, attention must be drawn to the fact that the hemicellulose containing additives can be admixed to the cellulose already during the production of the raw material for the tissue paper manufacture—i.e. during the manufacture of the corresponding cellulose pulp.

The hemicellulose of the present invention is xylan. Xylans, as used herein, are polymers of xylose, 5 carbon sugars, connected with 1,4-β bonds similar to cellulose, and derivatives thereof. Pure xylan generally has the formula

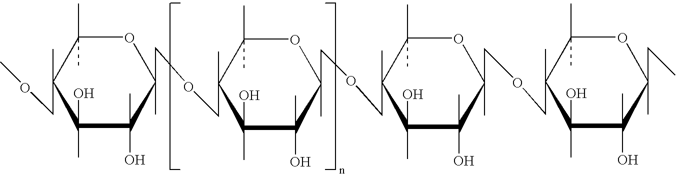

where n determines the size of the xylan polymer. Pure, unsubstituted xylan is rare in nature. In contrast to cellulose, the xylan polymers are highly substituted at the hydroxyl groups, which prevents crystallization. Most naturally occurring xylans are substituted to some degree. Please see Rydholm, Sven A., Pulping Processes, (1965).

Two xylan polymers, readily available from hardwood or softwood tree pulp, are representative of xylan derivatives useful in the present invention. Hardwoods contain high levels of 4-O-methyl-D glucuronoxylan acetate, represented by the formula

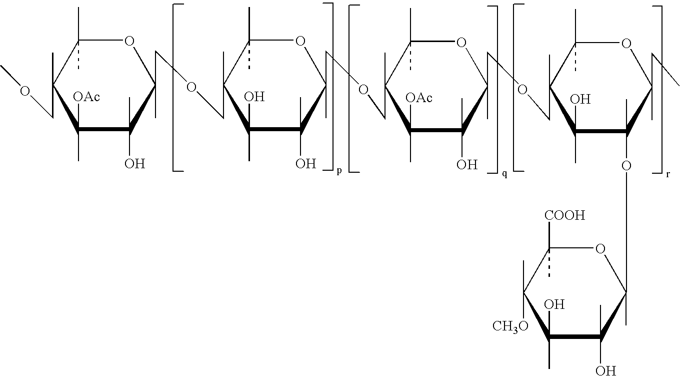

where p, q, and r may vary based on the amount of each monomer in the polymer. 4-O-methylglucuronoxylan acetate has acetyl groups attached at the C2 and C3 hydroxyls, a methyl glucuronic acid is attached via an α bond at C2 on the backbone. There are approximately 0.1 glucuronic acid units per xylose unit and approximately 0.7 to 0.8 acetate grooups per xylose in hardwood xylan.

Softwood tree pulps contain high levels of 4-O-methyl-D-glucuronoarabinoxylan, represented by the formula

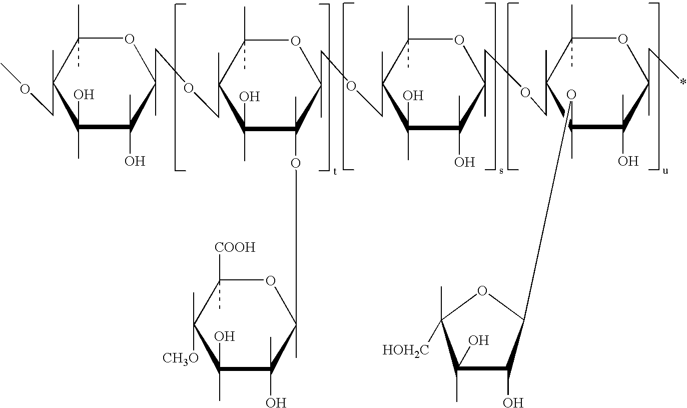

wherein t, s, and u may vary based on the amount of each monomer in the polymer. The 4-O-methyl-D-glucuronoarabinoxylan has approximately 0.2 glucuronic acid units per xylose unit while there are 0.3 acetate groups and 0.1 to 0.3 arabinose units per xylose unit. See Rydholm; Brit, Kenneth, Handbook of Pulp and Paper Technology, 2nd Edition, (1970); and Timell, T. E., Recent Progress in the Chemistry of Wood Hemicelluloses, Wood Science and Technology, Vol 1, 1967.

Xylan is used herein, includes all derivatives of the basic xylan compound, including but not limited to xylan with or without sidechains, with or without substituents, etc. Xylan is added to the furnish at a level ranging from 0.005% to about 0.14%, preferably from about 0.015% to about 0.1%, and more preferably from about 0.02% to about 0.05% by weight, based on the weight of cellulose.

Xylan may be delivered to the furnish in the form of a powder or, preferably a purified liquor, available from Lenzing, Inc., which may contain from 60% to 80% active xylan level. Alternatively, xylan may be delivered from slurries of highly refined pulps of trees containing xylans. Hardwoods (birch, beech, eucalyptus, etc.) have approximately 25% to 35% xylans, while softwoods have 9% to 14% xylans. Useful slurries of refined pulps have a Canadian Standard Freeness (TAPPI T227 OM-85—Freeness of Pulp Test) measurement less than about 350, preferably less than about 200, and most preferably less than about 100. The slurried also have a desired Schopper-Riegler slowness value (Standard test method EN ISO 5267-1) of greater than about 35°SR, preferably ranging from about 35°SR to about 90°SR, and most preferably from about 60°SR to about 80°SR.

The refining of pulp is accomplished by any means known in the industry to fibrillate the pulp fibers. These methods include typical milling equipment and/or refiners including a refining a slurry having a consistency of approximately 10% with a PFI mill; refining pulp slurries with appropriate Escher-Weiss refiners or Valley beaters. Appropriate refiners and beaters are based on slurry capacity with low consistency refiners used for slurries below about 7% slurry concentration, medium consistency mills used for slurries from about 7% to about 10%, and high consistency refiners used for slurries having a concentration above 10%.

In order to add the xylan of the present invention to the furnish, from about 0.1% to about 10%, preferably from about 3% to about 8%, and most preferably from about 4% to about 6% by weight of pulp in the slurry to the total pulp in the papermaking furnish.

Optional Chemical Additives

Other materials can be added to the aqueous papermaking furnish or the embryonic web to impart other desirable characteristics to the product or improve the papermaking process so long as they are compatible with the chemistry of the softening composition and do not significantly and adversely affect the softness or strength character of the present invention. The following materials are expressly included, but their inclusion is not offered to be all-inclusive. Other materials can be included as well so long as they do not interfere or counteract the advantages of the present invention.

It is common to add a cationic charge biasing species to the papermaking process to control the zeta potential of the aqueous papermaking furnish as it is delivered to the papermaking process. These materials are used because most of the solids in nature have negative surface charges, including the surfaces of cellulosic fibers and fines and most inorganic fillers. One traditionally used cationic charge biasing species is alum. More recently in the art, charge biasing is done by use of relatively low molecular weight cationic synthetic polymers preferably having a molecular weight of no more than about 500,000 and more preferably no more than about 200,000, or even about 100,000. The charge densities of such low molecular weight cationic synthetic polymers are relatively high. These charge densities range from about 4 to about 8 equivalents of cationic nitrogen per kilogram of polymer. An exemplary material is Retaminol MCS 301X®, a product of Bayer, Inc., Inc. of Pittsburgh, Pa. The use of such materials is expressly allowed within the practice of the present invention. When used such cationic charge biasing species, they are added to the papermaking furnish at a rate of from about 0.1 kg active/metric ton of finished paper (“kg/ton”) to about 2 kg/ton, preferably from about 0.3 kg/ton to about 1 kg/ton.

The use of high surface area, high anionic charge microparticles for the purposes of improving formation, drainage, strength, and retention is taught in the art. See, for example, U. S. Pat. No. 5,221,435, issued to Smith on Jun. 22, 1993, the disclosure of which is incorporated herein by reference.

If permanent wet strength is desired, cationic wet strength resins can be added to the papermaking furnish or to the embryonic web. Suitable types of such resins are described in U.S. Pat. Nos. 3,700,623, issued on Oct. 24, 1972, and 3,772,076, issued on Nov. 13, 1973, both to Keim. Other wet strength additives include epoxide resins, such as Kymene 450® and Kymene 2064® available from Hercules, Isovin® (isocyanate chemistry) from Bayer, Kenores® resins from Eka Chemical, Callaway® resins from Callaway, etc.

Many paper products must have limited strength when wet because of the need to dispose of them through toilets into septic or sewer systems. If wet strength is imparted to these products, fugitive wet strength, characterized by a decay of part or all of the initial strength upon standing in presence of water, is preferred. If fugitive wet strength is desired, the binder materials can be chosen from the group consisting of dialdehyde starch or other resins with aldehyde functionality such as Co-Bond 1000® offered by National Starch and Chemical Company of Scarborough, Me.; Parez 750®, Parez 631® and Parez 745® offered by Bayer, Inc. of Pittsburgh, Pa.; oxidized guar gums as disclosed in U.S. Pat. Nos. 5,760,212 and 5,698,688, both issued to Smith, the resin described in U.S. Pat. No. 4,981,557, issued on Jan. 1, 1991, to Bjorkquist, and other such resins having the decay properties described above as may be known to the art.

If enhanced absorbency is needed, surfactants may be used to treat the tissue paper webs of the present invention. The level of surfactant, if used, is preferably from about 0.01% to about 2.0% by weight, based on the dry fiber weight of the tissue web. The surfactants preferably have alkyl chains with eight or more carbon atoms. Exemplary anionic surfactants include linear alkyl sulfonates and alkylbenzene sulfonates. Exemplary nonionic surfactants include alkylglycosides including alkylglycoside esters such as Crodesta SL-40® which is available from Croda, Inc. (New York, N.Y.); alkylglycoside ethers as described in U.S. Pat. No. 4,011,389, issued to Langdon, et al. on Mar. 8, 1977; and alkylpolyethoxylated esters such as Pegosperse 200 ML available from Glyco Chemicals, Inc. (Greenwich, Conn.) and alkylpolyethoxylated ethers such as IGEPAL RC-520® and Fleetquest® from Kemira, Inc, and Neodol® from Shell, Inc. Alternatively, cationic softener active ingredients with a high degree of unsaturated (mono and/or poly) and/or branched chain alkyl groups can greatly enhance absorbency.

While the preferred embodiment of the present invention may also include variations in which chemical softening agents are added as a part of the papermaking process. For example, chemical softening agents may be included by wet end addition or by application to the dried sheet after making. Chemical softening agents comprise quaternary ammonium compounds including, but not limited to, the well-known dialkyldimethylammonium salts (e.g., ditallowdimethylammonium chloride, ditallowdimethylammonium methyl sulfate, di(hydrogenated tallow)dimethyl ammonium chloride, etc.). Other chemical softening agents comprise imidazoline compounds. Particularly preferred variants of these softening agents include mono or diester variations of the before mentioned dialkyldimethylammonium salts and ester quaternaries made from the reaction of fatty acid and either methyl diethanol amine and/or triethanol amine, followed by quaternization with methyl chloride or dimethyl sulfate.

Another class of papermaking-added chemical softening agents comprise the well-known organo-reactive polydimethyl siloxane ingredients, including the most preferred amino functional polydimethyl siloxane.

Filler materials may also be incorporated into the tissue papers of the present invention. U.S. Pat. No. 5,611,890, issued to Vinson et al. on Mar. 18, 1997, and, incorporated herein by reference discloses filled tissue paper products that are acceptable as substrates for the present invention.

The above listings of optional chemical additives is intended to be merely exemplary in nature, and are not meant to limit the scope of the invention.

### EXAMPLES

### Example 1

Initially, a xylan premix of 1% xylan and 2% sodium hydroxide is made or obtained. Such a premix may be obtained as a xylan liquor available from Lenzing.

Separately, a furnish for the paper making is produced. Eucalyptus sulfate cellulose (Pontevedra or Arracruz) and long fiber sulfite cellulose (Domsjö or Utansjö) are used as the raw material for the manufacture of a preferred embodiment of the tissue paper of the present invention. The long fiber sulfite cellulose has a Schopper-Riegler slowness value of SR°20 to 22. The eucalyptus sulfate cellulose only needs to be deflaked, but may be refined in the furnish if desired. The eucalyptus sulfate cellulose and long fiber sulfite cellulose are used in a weight ratio of about 30:70. The premix is added to the base furnish to achieve a level of 0.025% by weight based on the dry weight of the cellulose fibers. The pH of the furnish at this point ranges from about 8.0 to about 9.0, preferably from about 8.3 to about 8.8.

A paper web having a basis weight of 16 g/m² is made via a conventional papermaking machine. The running rate of the paper web through the machine is 1,750 m/min. The linear force of pressure of the two pressing rollers is between 80 and 90 kN/m. The desired solids content after the final drying at the output of the cylinder is fixed at 93.5% and the degree of creping ranges between 16 and 17%. The wire of the machine is a single-layer fabric (manufactured by Voith Fabrics). The delivery felt is of the “Delta 231.6 FC” type. The outer wire is a Wagner Finckh, Number 16608, duoply wire and the inner wire is a Wagner Finckh, Number 11894, monopoly wire.

### Example 2

A paper product of the present invention is made according to the process of Example 1, except that the ratio of eucalyptus sulfate cellulose to long fiber sulfite cellulose is about 70:30 and concentrated xylan premix or liquor is added at a level of 0.1% by weight based on the dry weight of cellulose fibers.

### Examples 3, 4 and 5

Paper products of the present invention are made by the processes described in Example 1, except that the xylan powder is added to the furnish at levels of 0.025%, 0.1%, and 0.3% respectively by weight based on the dry weight of cellulose fibers.

### Example 6

Initially, a slurry of refined birch pulp is made. Such a premix is produced by dispersing birch pulp in water in a 3% slurry and prerefining the pulp in a standard TAPPI can. The slurry is then thickened by filtration to about 10%. The 10% slurry is then refined by milling in a standard PFI mill until the slurry reaches a CSF of less than 350 and Schopper-Riegler of greater than about 35°SR.

Separately, a furnish for the paper making is produced. Eucalyptus sulfate cellulose (Pontevedra or Arracruz) and long fiber sulfite cellulose (Domsjö or Utansjö) are used as the raw material for the manufacture of a preferred embodiment of the tissue paper of the present invention. The long fiber sulfite cellulose has a Schopper-Riegler slowness value of SR°20 to 22. The eucalyptus sulfate cellulose only needs to be deflaked, but may be refined in the furnish if desired. The refined birch pulp is added to achieve a slurry comprising 5% by dry weight of the pulp to the total pulp in the furnish.

A paper web basis weight of 16 g/m² is made. The running rate of the paper web through the machine is 1,750 m/min. The linear force of pressure of the two pressing rollers is between 80 and 90 kN/m. The desired solids content after the final drying at the output of the cylinder is fixed at 93.5% and the degree of creping ranges between 16 and 17%. The wire of the machine is a single-layer fabric (manufactured by Voith Fabrics). The delivery felt is of the “Delta 231.6 FC” type. The outer wire is a Wagner Finckh, Number 16608, duoply wire and the inner wire is a Wagner Finckh, Number 11894, monopoly wire.

### Example 7

Initially, a slurry of refined birch pulp is made. Such a premix is produced by dispersing birch pulp in water in a 3% slurry and prerefining the pulp in a standard TAPPI can. The slurry is then thickened by filtration to about 10%. The 10% slurry is then refined by milling in a standard PFI mill until the slurry reaches a CSF of less than 350 and Schopper-Riegler of greater than about 35°SR.

Separately, a furnish for the paper making is produced. Eucalyptus sulfate cellulose (Pontevedra or Arracruz) and long fiber sulfite cellulose (Domsjö or Utansjö) are used as the raw material for the manufacture of a preferred embodiment of the tissue paper of the present invention. The long fiber sulfite cellulose has a Schopper-Riegler slowness value of SR°20 to 22. The eucalyptus sulfate cellulose only needs to be deflaked, but may be refined in the furnish if desired. The refined birch pulp is added to achieve a slurry comprising 1% by dry weight of the pulp to the total pulp in the furnish.

A paper web basis weight of 16 g/m² is made. The running rate of the paper web through the machine is 1,750 m/min. The linear force of pressure of the two pressing rollers is between 80 and 90 kN/m. The desired solids content after the final drying at the output of the cylinder is fixed at 93.5% and the degree of creping ranges between 16 and 17%. The wire of the machine is a single-layer fabric (manufactured by Voith Fabrics). The delivery felt is of the “Delta 231.6 FC” type. The outer wire is a Wagner Finckh, Number 16608, duoply wire and the inner wire is a Wagner Finckh, Number 11894, monopoly wire.

### Example 8

Initially, a slurry of refined birch pulp is made. Such a premix is produced by dispersing birch pulp in water in a 3% slurry and prerefining the pulp in a standard TAPPI can. The slurry is then thickened by filtration to about 10%. The 10% slurry is then refined by milling in a standard PFI mill until the slurry reaches a CSF of less than 350 and Schopper-Riegler of greater than about 35°SR.

Separately, a furnish for the paper making is produced. Eucalyptus sulfate cellulose (Pontevedra or Arracruz) and long fiber sulfite cellulose (Domsjö or Utansjö) are used as the raw material for the manufacture of a preferred embodiment of the tissue paper of the present invention. The long fiber sulfite cellulose has a Schopper-Riegler slowness value of SR°20 to 22. The eucalyptus sulfate cellulose only needs to be deflaked, but may be refined in the furnish if desired. The refined birch pulp is added to achieve a slurry comprising 5% by dry weight of the pulp to the total pulp in the furnish. A cationic charge biasing species, Retaminol MCS 301X® is added to the papermaking process at a rate of 0.3 kg/ton.

A paper web basis weight of 16 g/m² is made. The running rate of the paper web through the machine is 1,750 m/min. The linear force of pressure of the two pressing rollers is between 80 and 90 kN/m. The desired solids content after the final drying at the output of the cylinder is fixed at 93.5% and the degree of creping ranges between 16 and 17%. The wire of the machine is a single-layer fabric (manufactured by Voith Fabrics). The delivery felt is of the “Delta 231.6 FC” type. The outer wire is a Wagner Finckh, Number 16608, duoply wire and the inner wire is a Wagner Finckh, Number 11894, monopoly wire.

What is claimed is:

1. A tissue paper product comprising one or more plies of a tissue paper; wherein at least one of the plies comprises cellulose and from about 0.005% to about 0.14% by weight based on the weight of cellulose of xylan.

2. A tissue product according to claim 1 wherein at least one of the plies comprises from about 0.015% to about 0.1% by weight, based on the weight of cellulose of xylan.

3. A tissue product according to claim 1 wherein at least one of the plies comprises from about 0.02% to about 0.05% by weight, based on the weight of cellulose of xylan.

4. A tissue product according to claim 1 wherein the source of the xylan is from about 0.1% to about 10% of highly refined pulp refined to have a Canadian Standard Freeness measurement less than about 350 and a Schopper-Riegler slowness value greater than about 35°SR.

5. A tissue product according to claim 4 wherein the highly refined pulp has a Canadian Standard Freeness measurement less than about 100 and a Schopper-Riegler slowness value of from about 60°SR to about 80°SR

6. A tissue product according to claim 5 wherein the pulp is birch pulp.

7. A tissue product according to claim 1 further comprising from about 0.1 kg/ton to about 2 kg/ton of a cationic charge biasing species.

8. A tissue product according to claim 6 further comprising from about 0.1 kg/ton to about 2 kg/ton of a cationic charge biasing species.

9. A method for the manufacture of hygienic cellulose paper comprising the steps of:
a) producing a furnish comprising cellulose;
b) adding from about 0.005% to about 0.14% by weight, based on the weight of cellulose, xylan to the furnish;
c) forming the furnish into a paper web
d) drying the paper web; and
e) creping the dried paper web.

10. A method for the manufacture of hygienic cellulose paper according to claim 9 wherein the xylan addition step occurs before the paper web forming step.

11. A method for the manufacture of hygienic cellulose paper according to claim 9 wherein the xylan addition step occurs during the paper web forming step.

12. A method for the manufacture of hygienic cellulose paper according to claim 9 wherein the xylan is added in the form of a powder having an activity ranging from about 60% to about 80%.

13. A method for the manufacture of hygienic cellulose paper according to claim 9 wherein the xylan is added in the form of a highly refined sulfate pulp mixture having a Canadian Standard Freeness measurement less than about 350 and a Schopper-Riegler slowness value of from about 35°SR to about 90°SR.

14. A method for the manufacture of hygienic cellulose paper according to claim 13 wherein the pulp is birch.

15. A method for the manufacture of hygienic cellulose paper according to claim 9 wherein the xylan is added in the form of a concentrated liquor.

16. A method for the manufacture of hygienic cellulose paper according to claim 6 also comprising the step of adding from about 0.1 kg/ton finished paper to about 2 kg/ton of a cationic charge biasing species to the furnish.
